(19) United States
(12) Patent Application Publication
(10) Pub. No.: US 2024/0290999 A1
(43) Pub. Date: Aug. 29, 2024

(54) COMPRESSOR ASSEMBLY FOR A FUEL CELL SYSTEM, IN PARTICULAR FOR A FUEL CELL SYSTEM FOR COMMERCIAL VEHICLES

(71) Applicant: ZF CV Systems Global GmbH, Bern (CH)

(72) Inventors: Arne Reiners, Hannover (DE); Janik Ricke, Uetze (DE)

(21) Appl. No.: 18/655,044

(22) Filed: May 3, 2024

Related U.S. Application Data
(63) Continuation of application No. PCT/EP2022/080472, filed on Nov. 2, 2022.

(30) Foreign Application Priority Data
Nov. 4, 2021 (DE) 10 2021 128 753.7

(51) Int. Cl. H01M 8/04089; H01M 8/04029; H01M 8/0432

(52) U.S. Cl. CPC H01M 8/04089; H01M 8/04029; H01M 8/04373; H01M 2250/20

(57) ABSTRACT

A compressor assembly is for a fuel cell system, in particular for a fuel cell system for commercial vehicles. The compressor assembly has two compressors connected in series and an electric motor for driving the compressors. The compressors are configured to take in an air mass flow, to compress it and to discharge the compressed air mass flow as a reactant supply, and the second compressor is configured to further compress the air mass flow coming from the first compressor. The compressor assembly has an intercooler which is configured to cool the air mass flow from the first compressor before its entry into the second compressor.

### CROSS-REFERENCE TO RELATED APPLICATIONS

This application is a continuation application of international patent application PCT/EP2022/080472, filed Nov. 2, 2022, designating the United States and claiming priority from German application 10 2021 128 753.7, filed Nov. 4, 2021, and the entire content of both applications is incorporated herein by reference.

### TECHNICAL FIELD

The present disclosure relates to a compressor assembly for a fuel cell system, in particular for a fuel cell system for commercial vehicles, having two compressors connected in series and an electric motor for driving the compressor, wherein the compressors are configured to take in an air mass flow, to compress it and to discharge the compressed air mass flow as a reactant supply, and wherein the second compressor is configured to further compress the air mass flow coming from the first compressor.

### BACKGROUND

Two-stage compressor assemblies for providing an air supply are generally known. In fuel cell systems, there is a particular challenge in the provision of the air with a low parasitic power loss of the balance-of-plant (BoP) components. The parasitic power loss is to be understood as the energy per unit time which can no longer be used during the operation of the BoP components as a result of loss processes, for example friction or convection processes. The compressor assembly for the air supply of the fuel cell represents the largest secondary consumer in the system and is therefore responsible for a correspondingly prominent part of the parasitic power loss. The parasitic power loss represents a limit to the achievable energy efficiency.

### SUMMARY

In a compressor assembly of the type designated at the beginning, the present disclosure was based on an object of ameliorating the disadvantages described above as far as possible. In particular, it is an object of the disclosure to specify a compressor assembly which can be operated with improved energy efficiency.

The present disclosure achieves the aforementioned object in that the compressor assembly has an additional intercooler, which is configured to cool the air mass flow from the first compressor before its entry into the second compressor.

The disclosure is based on the finding that specific cooling of the air mass flow contributes to an increase in the efficiency of the compressor assembly. Via a reduction of the air temperature at a suitable point in the system, the compression can be brought close to the isothermal compression within compressors. As a result, the efficiency of the compressor assembly can be increased. This cooling step is particularly preferably carried out between the two compressors, and the intercooler can be integrated into the compressor assembly, to the benefit of installation space.

If the term air is used above and below, it should be understood in connection with the disclosure that this term can be replaced by oxygen and all oxygen-containing mixtures of substances which are suitable for operation of the compressor and the fuel cell. The term air is intended to be understood in particular as a collective term for oxygen and oxygen-containing mixtures of substances.

In an embodiment of the disclosure, the compressor assembly has a cooling circuit and a coolant pump which is connected to the cooling circuit in order to convey a coolant in the cooling circuit. In this way, various system components can be cooled in a regulated process. Here, in connection with the disclosure, the term coolant designates all fluids, in particular liquids, in the broader sense likewise fluids with non-solid or solid additives, for example suspensions, which are suitable for cooling the system components and with which a needs-based reduction in the air mass flow temperature within the fuel cell system can be achieved.

In a further embodiment of the disclosure, the compressor assembly has power electronics, wherein the power electronics are configured to control the electric motor, and wherein the power electronics preferably have an inverter. Furthermore, the power electronics are connected to the cooling circuit, wherein the power electronics are preferably connected downstream adjacent to the coolant pump in the cooling circuit. The effect of the latter is that the coolant which has the lowest temperature at the start of the cooling circuit runs first through the temperature-sensitive power electronics. In addition, it is advantageous to use in the power electronics an inverter with silicon carbide semiconductors, since the inverter has a high power density and is capable of functioning at high frequencies, for example in a region up to 100 kHz.

In connection with the disclosure, “adjacent” defines the functional succession of the components through which flow passes one after another. Using the above example: after flowing through the pump, the flow next passes through the power electronics. Adjacent components in this sense can be mounted directly on one another or else be at a distance from one another and connected via lines.

In connection with the disclosure, “downstream” defines the following arrangement of a component in the flow direction relative to a second component. Analogously, “upstream” defines the arrangement opposite thereto of the first component in the flow direction relative to the second component.

In a further embodiment of the disclosure, in the cooling circuit the electric motor is connected to the cooling circuit, preferably downstream adjacent to the power electronics.

In a further embodiment, the intercooler is connected to the cooling circuit, preferably downstream adjacent to the electric motor. It follows from this that during the cooling of the air mass flow between the two compressors, the cooling circuit that is already present is used, which may be of advantage with regard to a higher energetic efficiency of the fuel cell system.

In a further embodiment of the disclosure, the compressor assembly has a charge air cooler, which is connected to the cooling circuit, preferably downstream adjacent to the intercooler, and which is configured to cool the air mass flow with the coolant after the air leaves the second compressor.

In a further embodiment of the disclosure, the compressor assembly has a heat exchanger, which is connected to the cooling circuit, preferably downstream adjacent to the charge air cooler, and which is configured to cool coolant coming from the charge air cooler and to feed it to the coolant pump.

In a further embodiment of the disclosure, the intercooler has a coolant flow chamber, which is connected to the cooling circuit, and an internal duct led through the coolant flow chamber, wherein the internal duct is connected to the first and second compressor in a fluid-conducting manner and is configured to conduct the air mass flow. The intercooler also has a duct wall which is configured for heat transfer. The duct wall is dimensioned with an appropriate wall thickness in a generally known way for this purpose and consists partly or completely of a suitable heat-conducting material, preferably aluminum, steel or copper, or an alloy of one or more of the aforementioned metals.

In various embodiments, the coolant flow chamber has at least one coolant inlet and a coolant outlet, which are aligned in such a way that a flow direction relative to the flow direction of the air mass flow is defined. The coolant flow chamber can be configured geometrically such that the coolant flows around the internal duct, preferably opposite to the air mass flow or spirally.

In a further embodiment of the disclosure, the first compressor is configured to heat the air mass flow by a first temperature difference ΔT₁ relative to an inlet temperature T_{E} of the air mass flow, and the intercooler is configured to cool the air mass flow by a second temperature difference ΔT₂. It is not the intended object of the first compressor to increase the temperature of the air mass flow; the temperature increase is a technical consequence of the air compression. The second temperature difference ΔT₂ preferably lies in a region of 0.5·ΔT₁ or more. The effect of cooling the air mass flow becomes clear, for example, if the latter is cooled from a temperature of 120° C. as it leaves the first compressor stage to 70° C. as it enters the second compressor stage; as a result, the capacity needed in the second compressor decreases by more than 10%.

In a further embodiment of the disclosure, the compressor assembly has a thermostat, which is connected to the cooling circuit and on the inlet side additionally has a connection to a bypass, which is connected to a branch arranged downstream adjacent to the coolant pump, and has a valve assembly which is configured to mix coolant flowing out of the two inlets to a target temperature T_{M} and to lead it onward through an outlet downstream. Via the bypass, the supply of coolant at a lower temperature into the thermostat is thus made possible, as a result of which the mixing temperature T_{M} can be adjusted by the valve assembly.

In a further embodiment of the disclosure, the thermostat is arranged
between the power electronics and the electric motor, or
between the electric motor and the intercooler, or between the intercooler and the charge air cooler.

This makes it possible to be able to regulate the coolant temperature T_{K} more flexibly, depending on the cooling requirement of the system components.

In a further embodiment of the disclosure, the outlet is a first outlet, and the thermostat has a second outlet in the cooling circuit, which is connected to the heat exchanger via a duct, wherein the valve assembly is configured to lead coolant through the second outlet directly to the heat exchanger as a function of the coolant temperature T_{K}. If a sufficient reduction in the coolant temperature T_{K} within the thermostat for further use is not possible, the coolant can be led away via the direct fluid-conducting connection of the thermostat to the heat exchanger.

In a further embodiment of the disclosure, the intercooler is a first cooler, the charge air cooler is a second cooler, and the compressor assembly has an additional, third cooler, which is configured to cool the air mass flow leaving the second compressor. As a result, the cooling effort within the charge air cooler is reduced and the charge air cooler can accordingly be dimensioned to be smaller—and therefore more economical.

One, more or all of the coolers which have been described above in various embodiments are preferably partly or completely structurally integrated in the compressor assembly. Particularly preferably, at least the cooling ducts of the second cooler are structurally integrated in the second compressor stage.

In a further embodiment of the disclosure, the third cooler is connected between the intercooler and the thermostat in the cooling circuit and is configured to cool the air mass flow leaving the second compressor. Thus, the coolant coming from the intercooler is used for the cooling in the third cooler.

In a further embodiment of the disclosure, the compressor and the electric motor are arranged in a common housing, preferably together with the intercooler; and/or the power electronics are mounted on or in the housing; and/or the thermostat, and the third cooler and its supply lines are preferably integrated in the housing.

In a further embodiment of the disclosure, the cooling circuit has a bypass arrangement downstream adjacent to the coolant pump and upstream adjacent to the electric motor, which arrangement is configured to conduct the coolant coming from the coolant pump partly directly to the electric motor. To control the flow direction in the bypass arrangement, the bypass arrangement preferably has a multi-way valve, particularly preferably a spring-loaded 3/2-way solenoid valve. The multi-way valve is preferably configured to allow the envisaged coolant flow in the direction of the power electronics in a first position which, in a spring-loaded valve, may be an unactuated position. The multi-way valve is further preferably configured to block the original flow direction and instead to open the bypass in a second position which, for example, can be present when energized. This arrangement offers the advantage that in the event of an inadequately and/or adequately cool coolant flow from the power electronics, the latter can be partly or completely bypassed in the cooling circuit.

The invention has been described above in a first aspect with reference to a compressor assembly. As mentioned, the compressor assembly is intended to supply the fuel cell with air in a fuel cell system. Therefore, in a second aspect, the disclosure relates to a fuel cell system for a commercial vehicle, having a fuel cell with an inlet on the cathode side and a compressor assembly, which is connected in a fluid-conducting manner to the inlet of the fuel cell on the cathode side.

In a fuel cell system according to the second aspect, the disclosure achieves the object specified at the outset in that the compressor assembly is configured according to one of the embodiments described above. In this aspect, the disclosure makes use of the same advantages and findings as the compressor assembly according to the first aspect, so that in order to avoid repetitions, reference is made to the above explanations in this regard.

### BRIEF DESCRIPTION OF DRAWINGS

The invention will now be described with reference to the drawings wherein:

FIG. 1 shows a schematic representation of the compressor assembly according to a first embodiment;

FIG. 2 shows a schematic representation of an embodiment of the compressor assembly according to FIG. 1;

FIG. 3 shows a schematic representation of a further embodiment of the compressor assembly according to FIGS. 1 and 2;

FIG. 4 shows a schematic representation of a further embodiment of the compressor assembly according to FIGS. 1 to 3;

FIG. 5 shows a schematic representation of a further embodiment of the compressor assembly according to FIGS. 1 to 4; and,

FIG. 6 shows a schematic representation of a fuel cell system having a compressor assembly according to one of the above figures.

### DETAILED DESCRIPTION

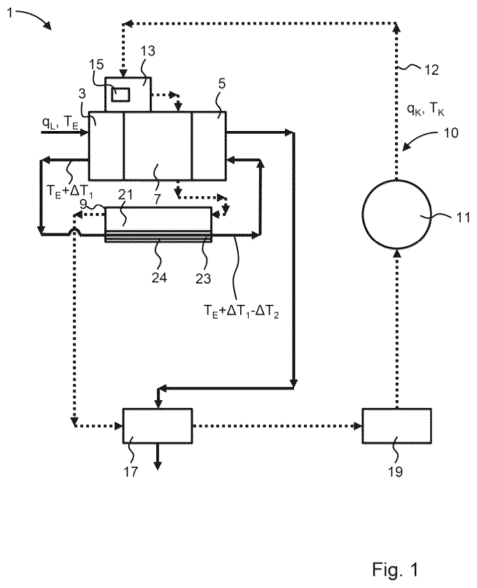

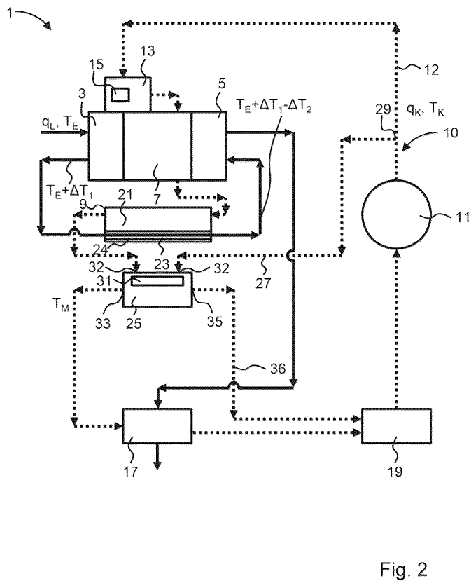

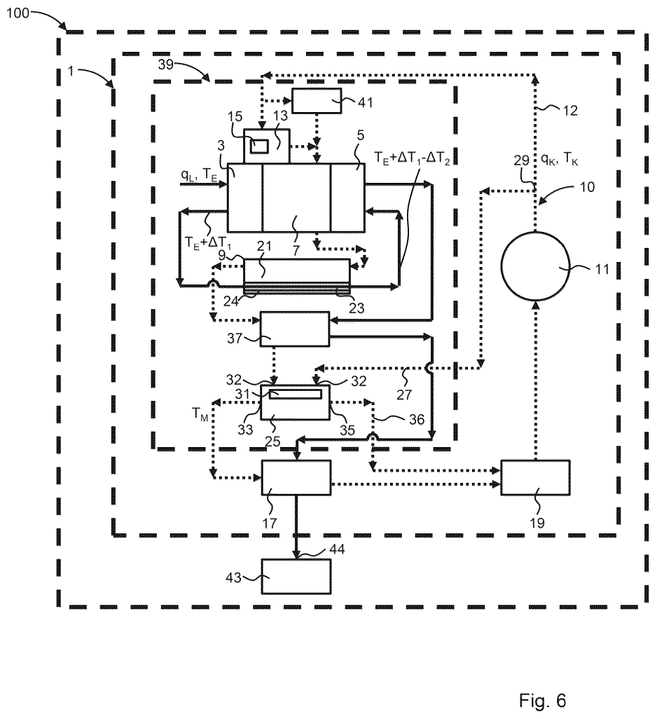

As explained in more detail below, the compressor assemblies illustrated in FIGS. 2 to 5 and the fuel cell system illustrated in FIG. 6 each show embodiments of the embodiment illustrated in FIG. 1. Those compressor assemblies are thus both instances of the embodiment according to FIG. 1, and also independent embodiments. Elements having the same structure and/or the same function are therefore respectively provided with the same designation in the figures.

FIG. 1 shows a compressor assembly 1 for a fuel cell system, in particular for a fuel cell system for commercial vehicles. The compressor assembly 1 has two compressors 3 and 5 and an electric motor 7 for driving the compressors. For the drive of the compressors, power electronics 13, in which amongst other things an inverter 15 is integrated, are arranged in the compressor assembly 1.

In order to cool the components, the compressor assembly 1 has a coolant pump 11, which is connected to a cooling circuit 10. The course and the flow direction of the coolant mass flow q_{K} in the cooling circuit 10 are indicated by the dashed lines having an arrow. In the embodiment shown in FIG. 1, the coolant 12 flows from the coolant pump 11 to the power electronics 13 and then to the electric motor 7.

The air mass flow q_{L} supplied from outside, the course of which is indicated by the continuous lines having an arrow, is compressed in the first compressor 3 and heated by the temperature difference ΔT₁. In order then to cool the air mass flow, the compressor assembly 1 has an intercooler 9, which includes a coolant flow chamber 21 and an internal duct 23, which is connected to the first compressor 3 downstream in a fluid-conducting manner. The air mass flow leaves the first compressor 3, is cooled by the temperature difference ΔT₂ in the internal duct of the intercooler and is then led onward into the second compressor 5, where further compression and renewed heating of the air mass flow are carried out.

The coolant flow chamber 21 is connected to the electric motor 7 downstream in a fluid-conducting manner in the cooling circuit 10. After passing through the intercooler 9, the coolant 12 in the embodiment shown in FIG. 1 then flows into the charge air cooler 17, where it is used to cool the air mass flow from the second compressor 5. The coolant 12 is then led to the heat exchanger 19, in which the coolant 12 is again cooled down. The coolant 12 is then led onward to the coolant pump 11. The air mass flow cooled in the charge air cooler 17 is led onward to the fuel cell.

The embodiment according to FIG. 2 shows a compressor assembly 1 in which, in addition to the embodiment shown in FIG. 1, the thermostat 25 is installed. The thermostat 25 is connected downstream adjacent to the intercooler 9 in the cooling circuit 10. The thermostat 25 has a second inlet, which is connected to a thermostat bypass 27, which is connected to a thermostat branch 29 arranged downstream adjacent to the coolant pump 11. The thermostat 25 is configured to mix coolant 12 entering via the two inlets by using a valve assembly 31. Because of the lower temperature of the coolant 12 flowing in via the bypass, the mixing temperature T_{M} of the coolant 12 can be adjusted. The coolant 12 is then led onward to the charge air cooler via an outlet 33 of the thermostat 25. The thermostat 25 additionally has a second outlet 35, which is connected to the heat exchanger 19 downstream in a fluid-conducting manner. Via the second outlet, coolant 12 can be fed directly to the heat exchanger 19 again if it cannot or is not to be used in the charge air cooler 17.

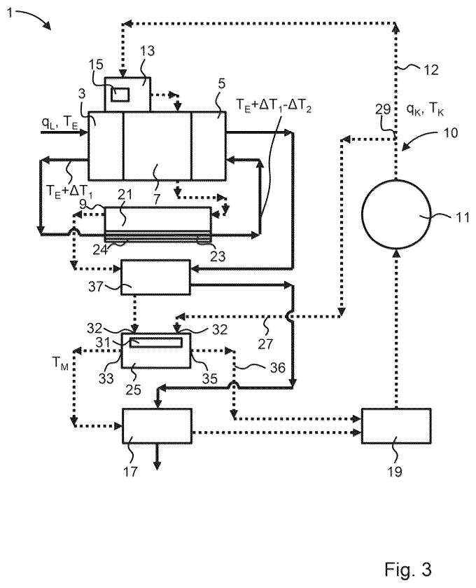

The embodiment according to FIG. 3 shows a compressor assembly 1 which, in addition to the embodiment shown in FIG. 2, has an additional, third cooler 37, which cools the air mass flow originating from the second compressor 5 before the air mass flow enters the charge air cooler 17. The third cooler 37 is connected to the intercooler 9 downstream in the cooling circuit 10. From the third cooler 37, the coolant 12 then flows to the thermostat 25.

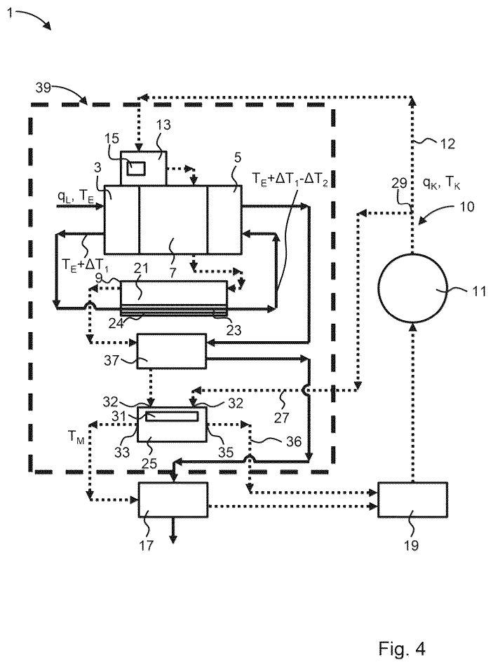

The embodiment according to FIG. 4 shows a compressor assembly 1 in which the compressor (3, 5), the electric motor (7), the intercooler (9), the power electronics (13) including the inverter (15), the thermostat (25) and the third cooler (37) are arranged in a housing (39).

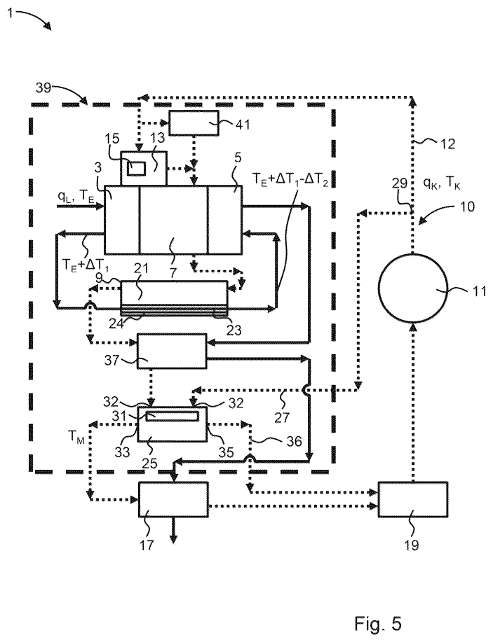

The embodiment according to FIG. 5 shows a compressor assembly 1 which, in addition to the embodiment shown in FIG. 4, has an additional bypass arrangement 41, which is connected downstream adjacent to the coolant pump 11 in the cooling circuit 10. The coolant 12 is led directly to the electric motor 7 via the bypass arrangement 41.

The embodiment according to FIG. 6 shows a compressor assembly 1 according to FIG. 5, which is connected in a fluid-conducting manner to the inlet 44 on the cathode side of the fuel cell 43 and, together with the fuel cell 43, forms the fuel cell system 100.

The fuel cell system 100 is illustrated in FIG. 6 with the compressor assembly 1 shown in FIG. 5. However, it should be understood that the fuel cell system 100 can include each of the embodiments of the compressor assembly 1 shown in FIGS. 1 to 5 and also a compressor assembly according to one, more or all of the embodiments described generally above.

Accordingly, the schematic representations shown in FIG. 1 to FIG. 6 are not restricted thereto. Instead, the illustrations are merely intended to indicate examples from a large number of possible combinations of the components of the fuel cell system.

It is understood that the foregoing description is that of the preferred embodiments of the invention and that various changes and modifications may be made thereto without departing from the spirit and scope of the invention as defined in the appended claims.

### LIST OF DESIGNATIONS (PART OF THE DESCRIPTION)

1 Compressor assembly
3 First compressor
5 Second compressor
7 Electric motor
9 Intercooler (first cooler)
10 Cooling circuit
11 Coolant pump
12 Coolant
13 Power electronics
15 Inverter
17 Charge air cooler (second cooler)
19 Heat exchanger
21 Coolant flow chamber in the intercooler
23 Internal duct in the intercooler
24 Duct wall
25 Thermostat
27 Thermostat bypass
29 Thermostat branch
31 Valve assembly
32 Inlets
33 First outlet of the thermostat
35 Second outlet of the thermostat
36 Duct from the intercooler to the heat exchanger
37 Third cooler
39 Housing
41 Bypass arrangement
43 Fuel cell
44 Inlet of the fuel cell on the cathode side
100 Fuel cell system
q_{K} Coolant mass flow
q_{L} Air mass flow
T₁ First temperature difference
T_{E} Inlet temperature
T₂ Second temperature difference
T_{M} Mixing temperature
T_{K} Coolant temperature

1. A compressor assembly for a fuel cell system, the compressor assembly comprising:
a first compressor and a second compressor connected in series;
an electric motor for driving said first compressor and said second compressor;
said first compressor and said second compressor being configured to take in an air mass flow to compress the air mass flow and to discharge the compressed air mass flow as a reactant supply;
said second compressor being configured to further compress the air mass flow coming from said first compressor; and,
an intercooler configured to cool the air mass flow from said first compressor before the air mass flow enters into said second compressor.

2. The compressor assembly of claim 1 further comprising a cooling circuit and a coolant pump connected to said cooling circuit in order to convey a coolant in said cooling circuit.

3. The compressor assembly of claim 2 further comprising power electronics configured to control said electric motor and connected to said cooling circuit.

4. The compressor assembly of claim 3, wherein said power electronics are connected downstream adjacent to said coolant pump in the cooling circuit.

5. The compressor assembly of claim 2, wherein said electric motor is connected to said cooling circuit.

6. The compressor assembly of claim 2, wherein said electric motor is connected to said cooling circuit downstream adjacent to the power electronics.

7. The compressor assembly of claim 2, wherein said intercooler is connected to said cooling circuit.

8. The compressor assembly of claim 2, wherein said intercooler is connected to said cooling circuit downstream adjacent to said electric motor.

9. The compressor assembly of claim 2 further comprising a charge air cooler connected to said cooling circuit and configured to cool the air mass flow with the coolant after the air leaves said second compressor.

10. The compressor assembly of claim 2 further comprising a charge air cooler connected to said cooling circuit downstream adjacent to the intercooler and configured to cool the air mass flow with the coolant after the air leaves said second compressor.

11. The compressor assembly of claim 9 further comprising a heat exchanger connected to said cooling circuit and configured to cool the coolant coming from the charge air cooler and to feed it to the coolant pump.

12. The compressor assembly of claim 9 further comprising a heat exchanger connected to said cooling circuit downstream adjacent to the charge air cooler and configured to cool the coolant coming from said charge air cooler and to feed it to said coolant pump.

13. The compressor assembly of claim 2, wherein said intercooler has a coolant flow chamber connected to said cooling circuit and an internal duct led through the coolant flow chamber; said internal duct is connected to said first compressor and said second compressor in a fluid-conducting manner and is configured to conduct the air mass flow; and, said intercooler has a duct wall configured for heat transfer.

14. The compressor assembly of claim 1, wherein said first compressor is configured to heat the air mass flow by a first temperature difference (ΔT₁) with respect to an inlet temperature of the air mass flow; and, said intercooler is configured to cool the air mass flow by a second temperature difference (ΔT₂), wherein the second temperature difference (ΔT₂) preferably lies in a region of 0.5·ΔT₁ or more.

15. The compressor assembly of claim 2 further comprising:
a thermostat connected to said cooling circuit and, on an inlet side, additionally having a connection to a thermostat bypass;
said thermostat bypass being connected to a thermostat branch arranged downstream adjacent to said coolant pump; and,
a valve assembly configured to mix the coolant flowing out of both inlets to a target temperature and to lead it onward downstream through an outlet of said thermostat.

16. The compressor assembly of claim 15, wherein said thermostat is arranged:
between said power electronics and said electric motor; or,
between said electric motor and said intercooler; or,
between said intercooler and said charge air cooler.

17. The compressor assembly of claim 15 further comprising:
a heat exchanger connected to said cooling circuit and configured to cool the coolant coming from a charge air cooler and to feed it to said coolant pump;
said outlet being a first outlet and said thermostat having a second outlet in said cooling circuit;
said second outlet being connected to said heat exchanger via a duct; and,
said valve assembly being configured to lead coolant through said second outlet directly to said heat exchanger as a function of the coolant temperature.

18. The compressor assembly of claim 9, wherein said intercooler is a first cooler, said charge air cooler is a second cooler, and the compressor assembly further comprises a third cooler configured to cool the air mass flow leaving said second compressor.

19. The compressor assembly of claim 18 further comprising:
a thermostat connected to said cooling circuit and, on an inlet side, additionally having a connection to a thermostat bypass;
said thermostat bypass being connected to a thermostat branch arranged downstream adjacent to said coolant pump;
a valve assembly configured to mix the coolant flowing out of both inlets to a target temperature and to lead it onward downstream through an outlet of said thermostat; and,
said third cooler is connected between said intercooler and said thermostat in said cooling circuit and is configured to cool the air mass flow leaving said second compressor.

20. The compressor assembly of claim 3, wherein at least one of:
said first compressor, said second compressor, and said electric motor are arranged in a common housing;
said first compressor, said second compressor, and said electric motor are arranged in a common housing with said intercooler;
said power electronics are mounted on or in said housing; and,
a thermostat and a third cooler and supply ducts thereof are integrated in the housing.

21. The compressor assembly of claim 4, wherein said cooling circuit has a bypass arrangement downstream adjacent to said coolant pump and upstream adjacent to said electric motor; and, said bypass arrangement is configured to lead the coolant coming from said coolant pump partly directly to said electric motor.

22. The compressor assembly of claim 1, wherein the fuel cell system is for a commercial vehicle.

23. A fuel cell system for a commercial vehicle, the fuel cell system comprising:
a fuel cell with an inlet on a cathode side;
a compressor assembly connected in a fluid-conducting manner to said inlet on the cathode side of said fuel cell;
said compressor assembly including a first compressor and a second compressor connected in series;
said compressor assembly further including an electric motor and an intercooler;
said electric motor for driving said first compressor and said second compressor;
said first compressor and said second compressor being configured to take in an air mass flow to compress the air mass flow and to discharge the compressed air mass flow as a reactant supply;
said second compressor being configured to further compress the air mass flow coming from said first compressor; and,
said intercooler configured to cool the air mass flow from said first compressor before the air mass flow enters into said second compressor.
